(19) United States
(12) Patent Application Publication
(10) Pub. No.: US 2023/0049265 A1
(43) Pub. Date: Feb. 16, 2023

(54) LAWNMOWER WITH REDUCED CLEARANCE SPACE

(71) Applicant: MILWAUKEE ELECTRIC TOOL CORPORATION, Brookfield, WI (US)

(72) Inventors: Christopher Shawn Bullington, Milwaukee, WI (US); Anthony J. Buxton, Wauwatosa, WI (US); John L. Whealon, West Bend, WI (US); Shane McCue, Greenfield, WI (US)

(21) Appl. No.: 17/884,743

(22) Filed: Aug. 10, 2022

Related U.S. Application Data
(60) Provisional application No. 63/231,561, filed on Aug. 10, 2021.

(51) Int. Cl. A01D 34/68; A01D 34/78; A01D 34/81; H01M 50/249; H01M 50/204; H01M 50/51

(52) U.S. Cl. CPC A01D 34/6806; A01D 34/78; A01D 34/81; H01M 50/249; H01M 50/204; H01M 50/51; A01D 2101/00

(57) ABSTRACT

A walk-behind lawnmower including a deck including a shroud, a front end portion, and a plurality of ribs coupled to the front end portion and defining a contact plane, a first motor, a rechargeable battery, and a blade rotatably driven by the first motor about a rotational axis, the blade having a tip defining a blade circle about the rotational axis. A radially inner surface of the shroud is disposed a first distance from a nearest point of the blade circle, the first distance being between 0.12 inches and 0.38 inches, a radially outer surface of the shroud is disposed a second distance from a nearest point of the blade circle, the second distance being between 0.5 inches and 0.75 inches, and the contact plane is disposed a third distance from a nearest point of the blade circle, the third distance being between 1.75 inches and 2.75 inches.

### CROSS-REFERENCE TO RELATED APPLICATIONS

This application claims priority to U.S. Provisional Patent Application No. 63/231,561 filed on Aug. 10, 2021, the entire contents of which are incorporated herein by reference.

### FIELD OF THE DISCLOSURE

The present disclosure relates to lawnmowers, and more particularly to walk-behind lawnmowers.

### BACKGROUND OF THE DISCLOSURE

Walk-behind lawnmowers typically include a frame, a deck, and a plurality of wheels. A rotating blade is located underneath the deck. The width of grass cut in one pass of the lawnmower is determined by the radius of the blade. Portions of the wheels, deck, and frame that extend beyond the radius of the blade may limit how close the lawnmower can cut to an object, such as a wall, rock, fence, tree, or the like. A subsequent trimming operation is typically required to cut grass within a clearance space between the outer boundary of the lawnmower and the radius of the blade. Thus, a need exists for a lawnmower with reduced clearance space to improve efficiency by reducing additional cutting passes and/or subsequent trimming operations.

### SUMMARY OF THE DISCLOSURE

The disclosure provides, in one aspect, a walk-behind lawnmower including a deck including a shroud having a radially inner surface and a radially outer surface, a front end portion coupled to the shroud, and a plurality of ribs coupled to the front end portion and extending away from the shroud, the plurality of ribs defining a contact plane. The walk-behind lawnmower further includes a first motor coupled to the deck and a rechargeable battery coupled to deck, the rechargeable battery configured to power the first motor. Moreover, the walk-behind lawnmower includes a blade rotatably driven by the first motor about a rotational axis, the blade at least partially surrounded by the shroud, the blade having a tip disposed radially outwardly from the rotational axis, the tip defining a blade circle about the rotational axis. The radially inner surface of the shroud is disposed a first distance from a nearest point of the blade circle, the first distance being between 0.12 inches and 0.38 inches. The radially outer surface of the shroud is disposed a second distance from a nearest point of the blade circle, the second distance being between 0.5 inches and 0.75 inches. The contact plane is disposed a third distance from a nearest point of the blade circle, the third distance being between 1.75 inches and 2.75 inches.

The disclosure provides, in another aspect a walk-behind lawnmower including a deck including a shroud and a front end portion coupled to the shroud. The front end portion defining a contact plane. The walk-behind lawnmower further includes at least one wheel coupled to the deck. The at least one wheel rotatable about an axle extending in a direction parallel to the contact plane. Moreover, the walk-behind lawnmower includes a blade coupled to the deck and rotatable about a rotational axis. The blade is at least partially surrounded by the shroud. The blade having a tip disposed radially outwardly from the rotational axis. The contact plane is between 1.75 inches and 2.75 inches from the tip of the blade with the tip of the blade nearest the contact plane.

Other features and aspects of the disclosure will become apparent by consideration of the following detailed description and accompanying drawings.

### BRIEF DESCRIPTION OF DRAWINGS

FIG. 1 is a perspective view of a lawnmower according to an embodiment of the present disclosure.

FIG. 2 is another perspective view of the lawnmower of FIG. 1, with a cover of a battery compartment hidden.

FIG. 3 is a perspective cross-sectional view of a portion of the lawnmower of FIG. 1.

FIG. 4 is a bottom view of the lawnmower of FIG. 1.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

### DETAILED DESCRIPTION

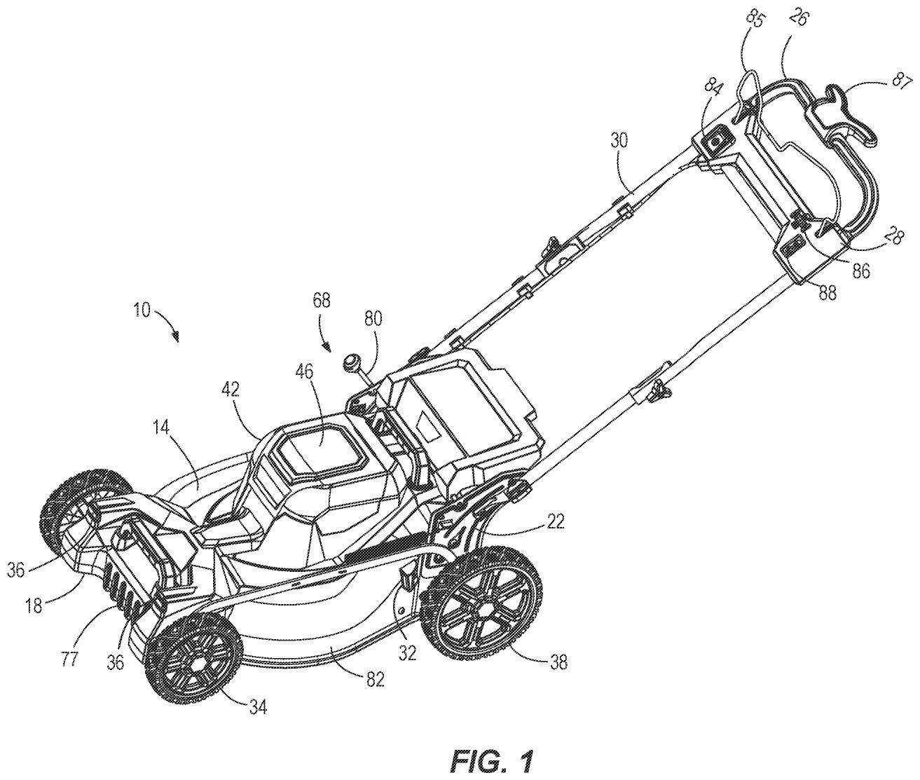

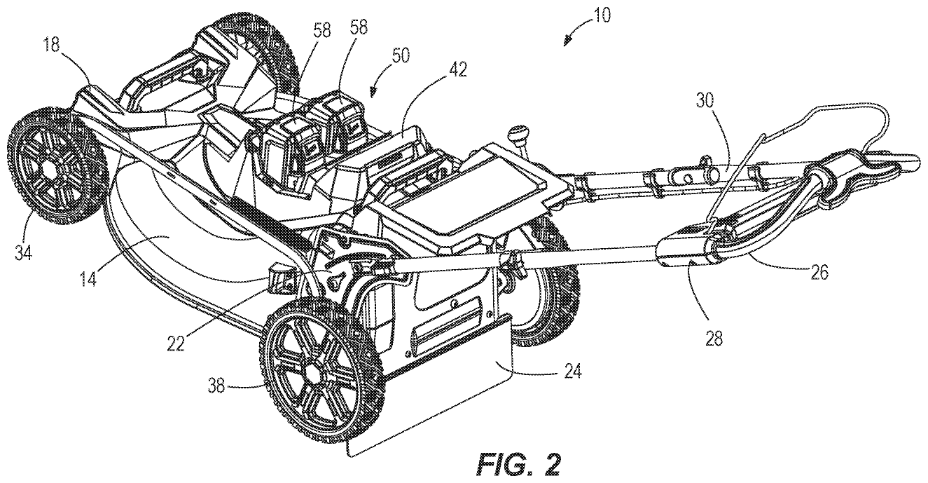

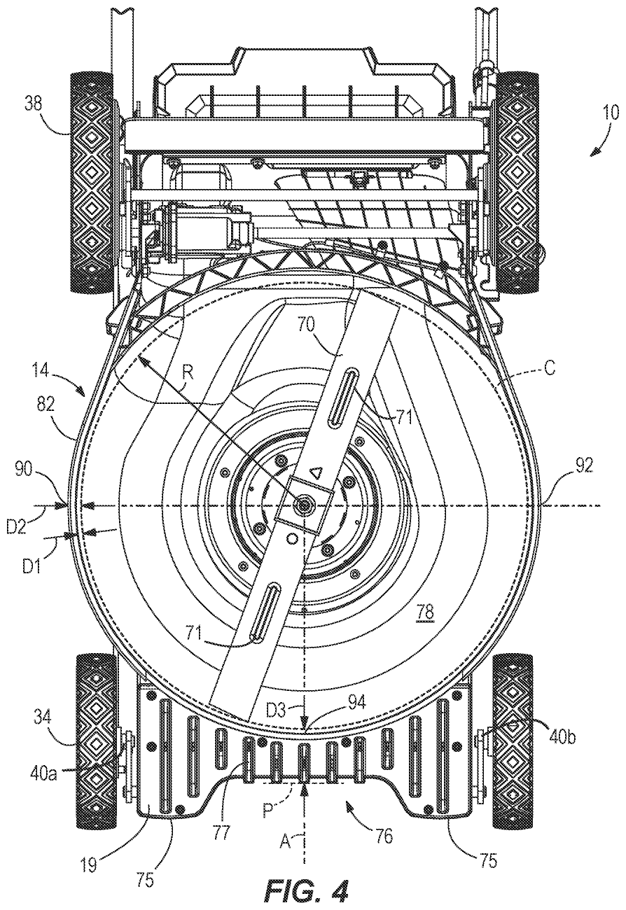

FIG. 1 illustrates a lawnmower 10, or a walk-behind lawnmower, according to one embodiment. The lawnmower 10 includes a deck 14, a front frame 18 coupled to a front end portion of the deck 14, a pair of brackets 22 coupled to a rear end portion of the deck 14, a handle 30 coupled to the brackets 22, and a rear guard 24 (FIG. 2) also coupled to the rear end portion of the deck 14. The handle 30 includes a gripping portion 26 and a panel 28 positioned below the gripping portion 26. The panel 28 of the handle 30 includes controls for operating the lawnmower 10. The deck 14 is supported by a pair of front wheels 34 and a pair of rear wheels 38, each rotatable about an axle (e.g., axle 40a, 40b in FIG. 4), such that the deck 14 can be rolled along a grass surface during use. The positions of the wheels 34, 38 relative to the deck 14 may be adjustable to vary a cut height of the lawnmower 10.

The lawnmower 10 further includes a grass bag (not shown) that is removably coupled to the rear end portion of the deck 14. The grass bag is configured to collect grass that has been cut during operation of the lawnmower 10. In other embodiments, the lawnmower 10 is operable without the grass bag being coupled to the deck 14. The lawnmower 10 also includes a first pair of LEDs 32 and a second pair of LEDs 36 configured to illuminate an area in which a user is operating the lawnmower 10. The first pair of LEDs 32 are coupled to the rear end portion of the deck 14 and direct light from the sides of the lawnmower 10. The second pair of LEDs 36 are coupled to the front frame 18 and direct light in a direction forward of the lawnmower 10.

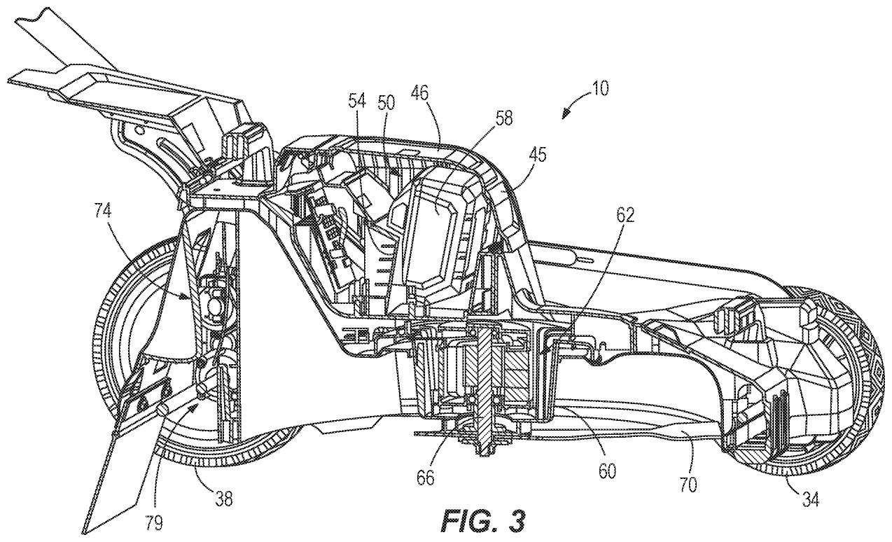

With reference to FIGS. 2-3, the illustrated lawnmower 10 includes a housing 42 supported on top of the deck 14. The housing 42 includes a lid 46 (FIG. 3), which encloses a battery compartment 50. The battery compartment 50 includes two battery receptacles 54, each configured to receive a battery 58 (e.g., a rechargeable power tool battery pack having a nominal output voltage of 18-Volts) such that the batteries 58 are accommodated within the battery compartment 50 in a side-by-side arrangement (FIG. 2). The lid 46 is pivotably coupled to the housing 42 to provide an open and closed configuration of the housing 42. In the open configuration, the battery compartment 50 is accessible and allows the user to remove or insert the batteries 58 into the battery compartment 50. In the closed configuration of the housing 42, the batteries 58 are securely coupled to the battery receptacles 54 as the lid 46 encloses the battery compartment 50.

Referring to FIG. 3, the lawnmower 10 includes a motor housing 60 and a first motor 62 housed within the motor housing 60. The first motor 62 is supportably coupled to a center of the deck 14 and has an output shaft 66 coupled to a blade 70 with a tip defined at each end of the blade 70. The blade 70 includes a pair of indentations 71 (FIG. 4) that protrudes towards the deck 14. In the illustrated embodiment, the first motor 62 is configured to directly drive the blade 70. In other embodiments, the first motor 62 may drive the blade 70 through a transmission, belt drive, or any other suitable drive mechanism. The first motor 62 is powered by the batteries 58 that are coupled in series to the first motor 62. The first motor 62 is preferably a brushless direct current (BLDC) motor, which provides greater power and efficiency than a brushed electric motor.

In the illustrated embodiment, the lawnmower 10 also includes a second motor 74 supportably coupled to the rear end portion of the deck 14. The second motor 74 is operably coupled to the rear wheels 38 (e.g., by a transmission 79, belt drive, or any other suitable drive arrangement) to selectively drive the rear wheels 38. As such, the lawnmower 10 may be configured as a rear-wheel-drive lawnmower 10. In other embodiments, the second motor 74 may be located in the front end portion of the deck 14 to selectively drive the front wheels 34, thereby configuring the lawnmower 10 as a front-wheel-drive lawnmower 10. In yet other embodiments, the second motor 74 may drive all four wheels 34, 38, or the second motor 74 may be omitted to configure the lawnmower 10 as a manual push mower. Like the first motor 62, the second motor 74 is also powered by the batteries 58.

Referring back to FIGS. 1 and 2, the lawnmower 10 includes a blade height adjustment mechanism 68 having a plate (not shown) coupled to one of the brackets 22 and a lever 80 coupled to the rear end portion of the deck 14. A plurality of notches is formed within the plate and is configured to receive the lever 80, thereby setting the blade 70 at a predetermined height above the grass surface. The lever 80 is configured to be moved by a user to adjust the height of the blade.

The panel 28 of the handle 30 includes a power button 84 configured to activate and deactivate the lawnmower 10, a bail bar 85, a speed dial 86, a variable speed self-propelled paddle 87, and a LED power button 88 configured to actuate the first and second pairs of LEDs 32,36. The bail bar 85 is configured to be gripped by a user to operate the lawnmower 10. The speed dial 86 controls the speed at which the blade 70 rotates. As such, the blade 70 can be operated at a low speed or a high speed. The variable speed self-propelled paddle 87 is configured to activate the lawnmower 10 such that the wheels 34, 38 are selectively driven by the second motor 74 so that a user does not have to push the lawnmower 10 without assistance.

In operation of the lawnmower 10, a user sets the speed of the blade 70 by adjusting the speed dial 86 to a predetermined speed outlined along the speed dial 86. If desired, the user can press the LED power button 88 to activate the first and second pairs of LEDs 32,36 to illuminate the area in which the lawnmower 10 will be operated. To activate the lawnmower 10, the user must pull and hold the bail bar 85 against the gripping portion 26 then press the power button 84. The first motor 62 is then actuated to drive the blade 70 to rotate, thereby providing a cutting operation. In some embodiments, the lawnmower 10 can be pushed by the user to operate as a manual lawnmower 10. In other embodiments, the variable speed self-propelled paddle 87 can be depressed by the user, so that the lawnmower 10 operates as a self-propelled lawnmower in which the second motor 74 drives either the front wheels 34 or the rear wheels 38. Once the user has completed the cutting operation, the user can release the self-propelled paddle 87 and the bail bar 85 to deactivate the lawnmower 10.

With reference to FIG. 4, the front frame 18 includes a pair of laterally spaced projecting portions 75 and a recess 76 extending between the projecting portions 75. The projection portions 75 are preferably made of an impact-resistant material, such as an impact-resistant plastic material. The front frame 18 may thus act as a bumper for the front end of the lawnmower 10. The illustrated deck 14 includes a plurality of ribs 77 coupled to the front frame 18, which may strengthen the construction of the front frame 18 and provide dimensional stability. Several of the plurality of ribs 77 extend along the recess 76, such that the ribs 77 define a contact plane P where an object entering the recess 76 may first contact the front frame 18. The contact plane P is oriented parallel to the rotational axis of the blade 70 and the axle. As illustrated in FIG. 4, the contact plane P defines the front end of the lawnmower 10 at a point along a longitudinal center axis A of the lawnmower 10. In some embodiments, the ribs 77 may be omitted from the recess 76, such that a back wall of the recess 76 may define the contact plane P.

With continued reference to FIG. 4, the deck 14 includes a top wall 78 and a curved shroud 82 extending downwardly from the top wall 78 and surrounding the blade 70. The shroud 82 defines a spacing in which the motor housing 60 and the first motor 62 extends therethrough. The blade 70 defines a radius R (i.e., a distance from a rotational axis of the blade 70 to an outermost point or tip of the blade 70). As the blade 70 rotates 360 degrees, the outermost point of the blade 70 thus defines a blade circle C having the radius R. A first distance D1 is defined between the blade circle C and an inner surface of the shroud 82. In the illustrated embodiment, the first distance D1 is constant for at least the front 180 degrees of the shroud 82. In some embodiments, the first distance D1 can be constant for less than 180 degrees of the shroud 82. In other embodiments, the first distance D1 is constant through a continuous 230 degrees of the shroud 82. That is, the first distance D1 is the same at each lateral side point 90, 92 of the shroud 82 and at a front point 94 of the shroud 82. Each of the lateral side points 90, 92 is offset 90 degrees from the front point 94. The first distance D1 is preferably between 0.12 inches (3.05 mm) and 0.38 inches (9.65 mm), and in the illustrated embodiment is about 0.25 inches (6.35 mm). In some embodiments, the distance D1 can be at less than about 1 inch (25.4 mm). In other embodiments, the distance D1 can be less than about 0.5 inches (12.7 mm).

A second distance D2 is defined between the blade circle C and an outer surface of the shroud 82 at the lateral side points 90, 92 of the shroud 82. The second distance D2 is preferably between 0.5 inches (12.7 mm) and 0.75 inches (19 mm), and in the illustrated embodiment is about 0.625 inches (15.88 mm). In some embodiments, the distance D2 can be less than about 2 inches (50.8 mm). In other embodiments, the distance D2 can be less than about 1 inch (25.4 mm). The distance D2 defines a lateral clearance of the lawnmower 10. For example, during a cutting operation, the lateral side points 90, 92 may abut an object, such as a tree, wall, fence, etc. The minimal second distance D2, which is equivalent to the distance D1 plus the thickness of the shroud 82, advantageously allows the lawnmower 10 to cut close against the object.

With continued reference to FIG. 4, a third distance D3 is defined between the blade circle C and the contact plane P. The third distance D3 is preferably between 1.75 inches (44.5 mm) and 2.75 inches (69.9 mm). In the illustrated embodiment, the third distance D3 is about 2.5 inches (63.5 mm). In other embodiments, the third distance D3 is about 2.25 inches (57.2 mm). In some embodiments, such as embodiments in which the ribs 77 are omitted, the third distance D3 may be about 2.0 inches (50.8 mm). The distance D3 defines a front clearance of the lawnmower 10. For example, during a cutting operation, the ribs 77 may abut the object at the contact plane P. The minimal third distance D3 advantageously allows the lawnmower 10 to cut close against the object.

Thus, the present disclosure provides a lawnmower 10 with reduced clearance space, advantageously able to cut close against objects and thereby improving efficiency.

Although the disclosure has been described in detail with reference to certain preferred embodiments, variations and modifications exist within the scope and spirit of one or more independent aspects of the disclosure as described.

What is claimed is:

1. A walk-behind lawnmower comprising:
a deck including
a shroud having a radially inner surface and a radially outer surface,
a front end portion coupled to the shroud, and
a plurality of ribs coupled to the front end portion and extending away from the shroud, the plurality of ribs defining a contact plane;
a first motor coupled to the deck;
a rechargeable battery coupled to deck, the rechargeable battery configured to power the first motor; and
a blade rotatably driven by the first motor about a rotational axis, the blade at least partially surrounded by the shroud, the blade having a tip disposed radially outwardly from the rotational axis, the tip defining a blade circle about the rotational axis,
wherein
the radially inner surface of the shroud is disposed a first distance from a nearest point of the blade circle, the first distance being between 0.12 inches and 0.38 inches,
the radially outer surface of the shroud is disposed a second distance from a nearest point of the blade circle, the second distance being between 0.5 inches and 0.75 inches, and
the contact plane is disposed a third distance from a nearest point of the blade circle, the third distance being between 1.75 inches and 2.75 inches.

2. The walk-behind lawnmower of claim 1, wherein the first distance is 0.25 inches.

3. The walk-behind lawnmower of claim 1, wherein the second distance is 0.625 inches.

4. The walk-behind lawnmower of claim 1, wherein the third distance is between 2 inches and 2.5 inches.

5. The walk-behind lawnmower of claim 11, wherein the third distance is 2.25 inches.

6. The walk-behind lawnmower of claim 1, wherein the rotational axis is parallel to the contact plane.

7. The walk-behind lawnmower of claim 1, wherein the first motor extends into a space defined by the shroud.

8. The walk-behind lawnmower of claim 1, wherein at least a portion of the rechargeable battery lies within a plane that intersects the motor and is parallel to the rotational axis.

9. The walk-behind lawnmower of claim 1, wherein the rechargeable battery is a first rechargeable battery, and further comprising a second rechargeable battery coupled to the deck, the second rechargeable battery configured to power the first motor.

10. The walk-behind lawnmower of claim 9, wherein the first rechargeable battery and the second rechargeable battery are identical.

11. The walk-behind lawnmower of claim 9, wherein the first rechargeable battery and the second rechargeable battery are coupled in series to power the first motor.

12. The walk-behind lawnmower of claim 9, further comprising a second motor coupled to the deck and powered by the first rechargeable battery and the second rechargeable battery.

13. The walk-behind lawnmower of claim 1, wherein the front end portion includes a pair of laterally spaced portions extending in a direction away from the shroud to define a forwardmost point of the deck.

14. The walk-behind lawnmower of claim 13, wherein the pair of laterally spaced portions defines a recess extending between the laterally spaced portions into which the plurality of ribs extends.

15. A walk-behind lawnmower comprising:
a deck including
a shroud, and
a front end portion coupled to the shroud, the front end portion defining a contact plane;
at least one wheel coupled to the deck, the at least one wheel rotatable about an axle, the axle extending in a direction parallel to the contact plane; and
a blade coupled to the deck and rotatable about a rotational axis, the blade at least partially surrounded by the shroud, the blade having a tip disposed radially outwardly from the rotational axis,
wherein the contact plane is between 1.75 inches and 2.75 inches from the tip of the blade with the tip of the blade nearest the contact plane.

16. The walk-behind lawnmower of claim 15, wherein the contact plane is between 2 inches and 2.5 inches from the tip of the blade with the tip of the blade nearest the contact plane.

17. The walk-behind lawnmower of claim 16, wherein the contact plane is 2.25 inches from the tip of the blade with the tip of the blade nearest the contact plane.

18. The walk-behind lawnmower of claim 15, wherein the rotational axis is parallel to the contact plane.

19. The walk-behind lawnmower of claim 15, further comprising a first motor coupled to the deck and configured to drive the blade about the rotational axis.

20. The walk-behind lawnmower of claim 19, further comprising a second motor operably coupled to a pair of rear wheels to selectively drive the pair of rear wheels as the blade is being rotatably driven by the first motor.
